(19) United States
(12) Patent Application Publication
(10) Pub. No.: US 2026/0005438 A1
(43) Pub. Date: Jan. 1, 2026

(54) ANTENNA DEVICE AND COMMUNICATION TERMINAL DEVICE

(71) Applicant: Murata Manufacturing Co., Ltd., Nagaokakyo-shi (JP)

(72) Inventor: Shigeyuki FUJIEDA, Nagaokakyo-shi (JP)

(73) Assignee: Murata Manufacturing Co., Ltd., Nagaokakyo-shi (JP)

(21) Appl. No.: 19/319,791

(22) Filed: Sep. 5, 2025

Related U.S. Application Data
(63) Continuation of application No. PCT/JP2024/002354, filed on Jan. 26, 2024.

(30) Foreign Application Priority Data
Apr. 24, 2023 (JP) 2023-070812

(51) Int. Cl. H01Q 5/30; H01Q 7/00

(52) U.S. Cl. CPC H01Q 5/30; H01Q 7/00

(57) ABSTRACT

An antenna device and a communication terminal device that offer broader frequency bands or compatibility with a plurality of frequency bands without degrading an antenna characteristic are provided. An antenna device of the includes a first antenna including a loop structure and a second antenna of open type. The first antenna includes a first radiating element, a first coil connected in series to the first radiating element, and a first conductor. The second antenna includes a second radiating element, a second coil connected in series to the second radiating element and magnetically coupled with the first coil, and a second conductor. A feed circuit that transmits and receives a radio frequency signal is connected in series with the first radiating element or the second radiating element. The second radiating element is arranged outside the loop structure of the first antenna.

### CROSS-REFERENCE TO RELATED APPLICATIONS

The present application is a continuation of International Application No. PCT/JP2024/002354, filed Jan. 26, 2024, which claims priority to Japanese Patent Application No. 2023-070812, filed Apr. 24, 2023, the entire contents of each of which being incorporated herein by reference.

### TECHNICAL FIELD

The present disclosure relates to technologies relating to antenna devices and communication terminal devices.

### BACKGROUND ART

In recent years, in order to offer broader frequency bands or compatibility with a plurality of frequency bands, a communication terminal device uses an antenna device including two radiating elements that are coupled with each other directly or indirectly. International Publication No. 2018/101285 (Patent Document 1) illustrates an antenna device in which two radiating elements are magnetically coupled using a transformer element.

### CITATION LIST

### Patent Documents

Patent Document 1: International Publication No. 2018/101285

### SUMMARY

### Technical Problems

In the antenna device illustrated in Patent Document 1, the first radiating element that forms a loop antenna and the second radiating element that forms a monopole antenna are magnetically coupled using a transformer element. However, the configuration of the antenna device illustrated in Patent Document 1 is such that the second radiating element forming the monopole antenna is arranged inside a loop formed from the first radiating element forming the loop antenna and ground (GND). Because of this, the second radiating element forming the monopole antenna may become close to a ground (GND) area, and this may degrade an antenna characteristic (for example, radiation efficiency).

The present disclosure is made to resolve the issues described above and to provide an antenna device and a communication terminal device that offer broader frequency bands or compatibility with a plurality of frequency bands without degrading an antenna characteristic.

### Solutions to Problems

An antenna device according to the present disclosure is an antenna device that includes a first antenna including a loop structure and a second antenna of open type. The first antenna includes a first radiating element, one end portion of which is directly connected to ground, a first coil that is connected in series to the first radiating element, and a first conductor that connects the first coil to the ground. The second antenna includes a second radiating element, one end portion of which forms an open end, a second coil that is connected in series to the second radiating element and magnetically coupled with the first coil, and a second conductor that connects the second coil to the ground. A feed circuit that transmits and receives a radio frequency signal is connected in series to the first radiating element or the second radiating element. The second radiating element is arranged outside the loop structure of the first antenna.

A communication terminal device according to the present disclosure includes a feed circuit and the foregoing antenna device.

### Advantageous Effects

In the antenna device of the present disclosure, the second radiating element is arranged outside the loop structure of the first antenna. Thus, the antenna device of the present disclosure is capable of offering broader frequency bands or compatibility with a plurality of frequency bands without degrading the antenna characteristic.

### BRIEF DESCRIPTION OF DRAWINGS

FIG. 1 is a schematic diagram of an antenna device according to an embodiment.

FIG. 2 is a schematic diagram illustrating a communication terminal device according to an embodiment.

FIG. 3 is a diagram illustrating a frequency characteristic of radiation efficiency of the antenna device according to the embodiment.

FIG. 4 is a diagram to illustrate coupling of antennas.

FIG. 5 illustrate an antenna device according to a modified example 1.

FIG. 6 is a schematic diagram of an antenna device according to a modified example 2.

FIG. 7 is a schematic diagram of an antenna device according to a modified example 3.

FIG. 8 is a schematic diagram of an antenna device according to a modified example 4.

FIG. 9 illustrate antenna device according to a modified example 5.

FIG. 10 is a schematic diagram of an antenna device according to a modified example 6.

FIG. 11 is a schematic diagram of an antenna device according to a modified example 7.

FIG. 12 is a schematic diagram of an antenna device according to a modified example 8.

### DESCRIPTION OF EMBODIMENTS

Hereinafter, embodiments of the present disclosure will be described in detail with reference to the drawings. Note that the same reference characters are assigned to the same or corresponding parts in the drawings, and the descriptions thereof will not be repeated.

### EMBODIMENT

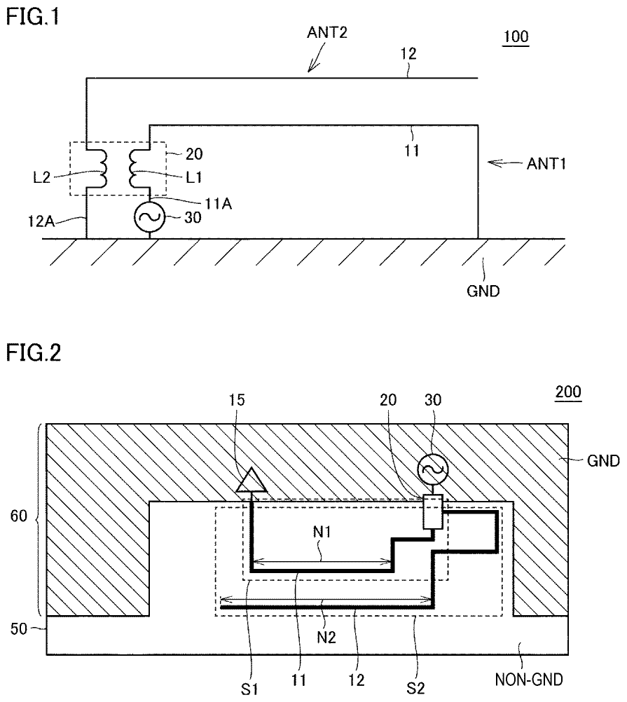

FIG. 1 is a schematic diagram of an antenna device 100 according to an embodiment. The antenna device 100 includes a first antenna ANT1 and a second antenna ANT2. The first antenna ANT1 includes a first radiating element 11, a first end portion of which is directly connected to ground, a first coil L1 that is connected in series to the first radiating element 11, and a first conductor 11A that connects the first coil L1 to the ground. The first conductor 11A is connected in series to a feed circuit 30. The first antenna ANT1 functions as a loop antenna that includes a loop structure in which a first end portion of the first radiating element 11 is directly connected to the ground (GND) and a second end portion of the first radiating element 11 is indirectly connected to the ground through a path including the first coil L1 and the first conductor 11A. Note that as long as the first antenna ANT1 has a loop structure, the shape thereof is not limited to that illustrated in FIG. 1.

The second antenna ANT2 includes a second radiating element 12, a first end portion of which forms an open end, a second coil L2 that is connected in series to the second radiating element 12, and a second conductor 12A that connects the second coil L2 to the ground. The second antenna ANT2 is an open-type antenna (for example, monopole antenna) in which a first end portion of the second radiating element 12 forms an open end and a second end portion of the second radiating element 12 is indirectly connected to the ground through a path including the second coil L2 and the second conductor 12A. Note that, as long as the second antenna ANT2 is an open-type antenna, it is not limited to the monopole antenna illustrated in FIG. 1. Further, the first coil L1 and the second coil L2 are magnetically coupled with each other. Because of this, while the first antenna ANT1 functions as a fed antenna that receives power from the feed circuit 30, the second antenna ANT2 functions as a parasitic antenna that receives no power from the feed circuit 30.

For example, the first coil L1 and the second coil L2 are installed in the antenna device 100 as a transformer element 20. The transformer element 20 is, for example, a chip component having a rectangular parallelepiped shape. The transformer element 20 is configured by forming conductor patterns of parts of the first coil L1 and the second coil L2 on respective insulating base materials (for example, liquid crystal polymer, low temperature cofired ceramics, or the like) and by stacking these insulating base materials on top of each other.

In antenna devices installed in mobile terminals such as smartphones and the like, part of the housing is used as a loop antenna due to limitations of mounting space. As a result, the second radiating element is arranged inside the loop formed from the first radiating element and the ground. In the case where the second radiating element is arranged inside the loop formed from the first radiating element and the ground, the second radiating element is arranged close to the ground area. This may degrade the radiation efficiency (antenna efficiency) of the second radiating element that functions as the monopole antenna. In view of this, in the antenna device 100, as illustrated in FIG. 1, the second radiating element 12 is arranged outside the loop structure of the first antenna ANT1, which is formed from the first radiating element 11 and the ground.

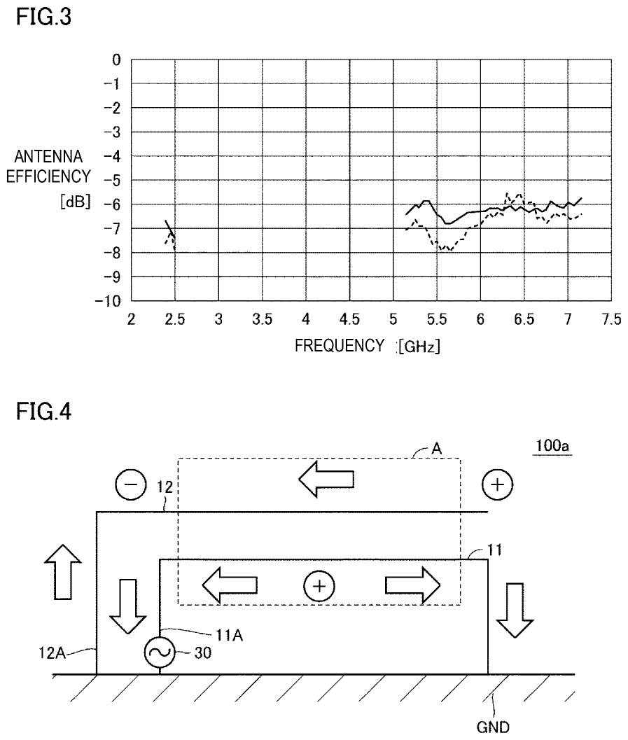

Specifically, a case is described in which the antenna device 100 is installed in a communication terminal device. FIG. 2 is a schematic diagram illustrating a communication terminal device 200 according to an embodiment. Note that in FIG. 2, the illustrations of the first conductor 11A and the second conductor 12A are omitted. The communication terminal device 200 illustrated in FIG. 3 is capable of, for example, performing communication in a band including a range from about 2.3 GHZ to about 2.5 GHZ and a band including a range from about 5 GHZ to about 7.5 GHZ. For example, the communication terminal device 200 is a notebook-size personal computer, and a board 60 on which the antenna device 100 is provided is mounted on part of a housing 50.

On the board 60, the first radiating element 11, the second radiating element 12, the transformer element 20, and the feed circuit 30 are mounted. The first radiating element 11, the second radiating element 12, and the transformer element 20 constitute the antenna device 100. The first radiating element 11 and the second radiating element 12 are magnetically coupled with each other via the transformer element 20, as illustrated in FIG. 1. The first radiating element 11 forms the loop antenna by connecting a first end portion of the first radiating element 11 to a terminal 15 for direct connection to the ground (GND) and by indirectly connecting a second end portion of the first radiating element 11 to the ground via the transformer element 20 and the feed circuit 30. For a fundamental wave λ, the loop antenna resonates in the case where the loop antenna has a size of λ/2, and the monopole antenna resonates in the case where the monopole antenna has a size of λ/4. Because of this, when the comparison is made using the fundamental wave, the size of the loop antenna becomes about twice the size of the monopole antenna. Thus, the loop antenna has a higher impedance and a higher radiation resistance, and this makes the loop antenna less prone to the effects of the ground. Accordingly, even in the case where the loop antenna is arranged close to the ground area, the radiation efficiency is less likely to degrade.

Because the second radiating element 12 forms the monopole antenna, the second radiating element 12 is prone to the effects of the ground. Thus, the second radiating element 12 is arranged outside the loop structure of the first antenna ANT1 formed from the first radiating element 11 and the ground to alleviate the effects of the ground and suppress the degradation of the radiation efficiency.

FIG. 3 is a diagram illustrating the frequency characteristic of radiation efficiency of the antenna device 100 according to the embodiment. In FIG. 3, the horizontal axis is the frequency, and the vertical axis is the radiation efficiency. A solid line graph illustrated in FIG. 3 represents the frequency characteristic of the radiation efficiency of the antenna device 100, and a dashed line graph illustrated in FIG. 3 represents the frequency characteristic of the radiation efficiency of a typical inverted-F antenna (IFA). Particularly, as can be seen from FIG. 3, the radiation efficiency of the antenna device 100 does not degrade in a band including a range from about 5 GHz to about 6 GHz and is capable of maintaining high radiation efficiency.

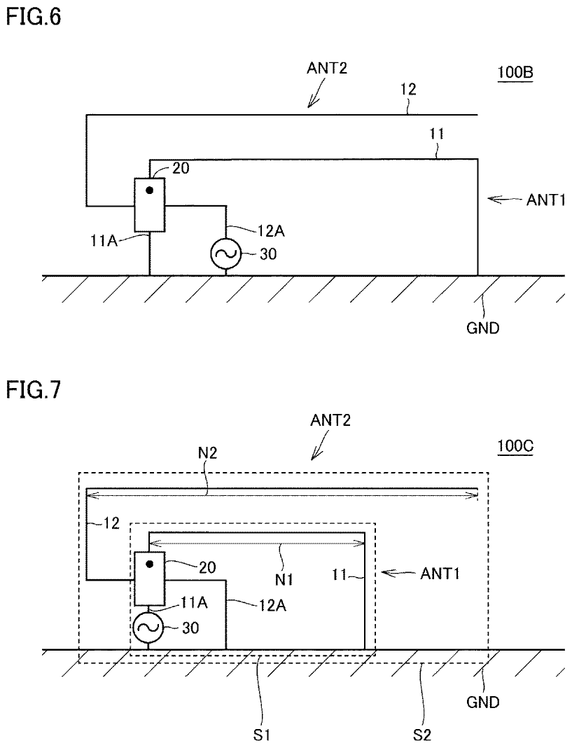

As illustrated in FIG. 2, the board 60, on which the antenna device 100 is provided, includes an area S1 where the first radiating element 11 is formed and an area S2 where the second radiating element 12 is formed. The shapes of the areas S1 and S2 are both rectangular. In the antenna device 100C, a length N1 of a first part of the first radiating element 11 that extends in the longer side direction (left-and-right direction of the drawing) of the area S1 where the first radiating element 11 is formed is substantially the same as or shorter than a length N2 of a second part of the second radiating element 12 that extends in the longer side direction (left-and-right direction of the drawing) of the area S2 where the second radiating element 12 is formed (N1≤N2). Further, the first part of the first radiating element 11 that extends in the longer side direction of the area S1 where the first radiating element 11 is formed and the second part of the second radiating element 12 that extends in the longer side direction of the area S2 where the second radiating element 12 is formed are arranged to run alongside each other. In other words, the first part and the second part extend in parallel direction and overlap along a direction orthogonal to the longer side direction and the first part is shorter than the second part, i.e., the second part completely overlaps the first part. While the second part of the second radiating element 12 in the antenna device 100B of FIG. 6 is also longer than the first part of the first radiating element 11, first ends of the first part and second part extend to a same point along the longer side direction, e.g., to the right side.

In order to couple the fundamental wave of the monopole antenna with the fundamental wave of the loop antenna, the length of the loop antenna may be about twice the length of the monopole antenna. However, as illustrated in FIG. 2, in the antenna device 100, the length N1 of the first part of the first radiating element 11 that extends in the longer side direction of the area S1 where the first radiating element 11 is formed is substantially the same as or shorter than the length N2 of the second part of the second radiating element 12 that extends in the longer side direction of the area S2 where the second radiating element 12 is formed. This means that a harmonic wave (three times the wavelength of the fundamental wave) of the second antenna ANT2 that forms the monopole antenna couples with the fundamental wave of the first antenna ANT1 that forms the loop antenna.

Because of this, in the antenna device 100, when the resonant frequency of the fundamental wave of the first antenna ANT1 and the resonant frequency of the fundamental wave of the second antenna ANT2 are compared, the resonant frequency of the fundamental wave of the first antenna ANT1 is higher than the resonant frequency of the fundamental wave of the second antenna ANT2. Note that one of the harmonic wave of the second antenna ANT2 and the fundamental wave of the first antenna ANT1, which are coupled with each other, may be higher than the other. That is to say, the resonant frequency of the fundamental wave of the first antenna ANT1 may be lower than the resonant frequency of the harmonic wave of the second antenna ANT2, or the resonant frequency of the fundamental wave of the first antenna ANT1 may be higher than the resonant frequency of the harmonic wave of the fundamental wave of the second antenna ANT2. For communication at the frequency to use, the fundamental wave or a harmonic wave of any antenna may be arbitrarily selected. However, the downsizing of antenna becomes possible by setting the communication frequency on the low frequency side to the fundamental wave of the second antenna ANT2 and setting the communication frequency on the high frequency side to the fundamental frequency of the first antenna ANT1.

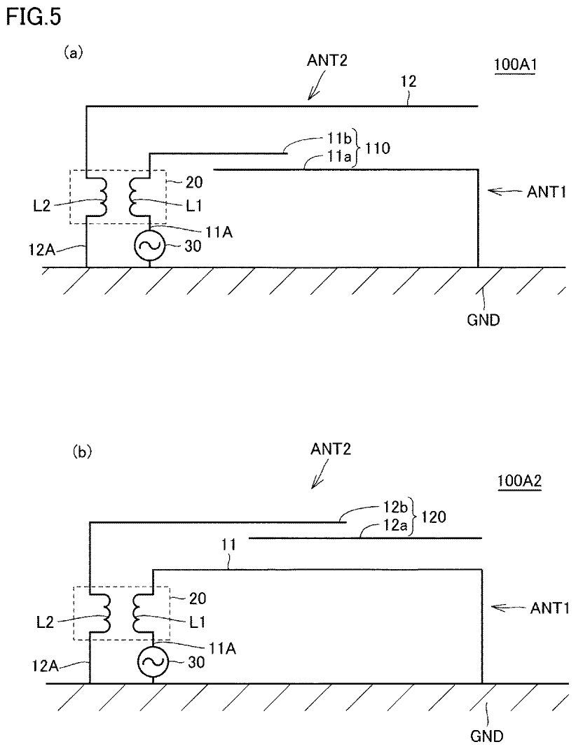

Next, the transformer element 20 couples the harmonic wave of the second antenna ANT2 with the fundamental wave of the first antenna ANT1 in the antenna device 100 is described. FIG. 4 is a diagram to illustrate the coupling of the antennas. An antenna device 100a illustrated in FIG. 4 does not include the transformer element 20. The first radiating element 11 functions as a loop antenna that includes a loop structure in which the first end portion of the first radiating element 11 is directly connected to the ground and the second end portion of the first radiating element 11 is indirectly connected to the ground via the first conductor 11A. The first conductor 11A is connected in series to the feed circuit 30. The second radiating element 12 functions as an open-type antenna (monopole antenna) in which the first end portion of the second radiating element 12 forms an open end and the second end portion of the second radiating element 12 is indirectly connected to the ground via the second conductor 12A.

In the antenna device 100a, within a dashed line frame illustrated in FIG. 4, the directions of currents represented by arrows do not remain the same. That is to say, in the loop antenna, the current flows relative to the center of the antenna, which serves as the base point, at the time of resonating with the fundamental wave. On the other hand, in the monopole antenna, the current flows in the same direction at the time of resonating. Thus, there exists the part where the directions of the currents coincide and the part where the directions of the currents do not coincide. When the directions of currents in the first radiating element 11 and the second radiating element 12 remain the same, the harmonic wave of the second radiating element 12 and the fundamental wave of the first radiating element 11 can be coupled even without the transformer element 20. However, when the directions of the currents do not remain the same, the harmonic wave of the second radiating element 12 and the fundamental wave of the first radiating element 11 are coupled with each other by using magnetic coupling between the first coil L1 and the second coil L2. Thus, the transformer element 20 is in the antenna device 100a, as in the antenna device 100 illustrated in FIG. 1.

### Modified Example 1

In the antenna device 100 illustrated in FIG. 1, the configuration is described in which the entire part of the first radiating element 11 is directly connected to the feed circuit 30 via the first coil L1 and the first conductor 11A. However, the entire part of the first radiating element 11 may not be connected to the feed circuit 30 via the first coil L1 and the first conductor 11A, i.e., the first radiating element 11 may have a part that is indirectly connected to the feed circuit 30. FIG. 5 illustrate an antenna device 100A according to a modified example 1. In the antenna devices 100A1 and 100A2 illustrated in (a) and (b) of FIG. 5, the same reference characters are assigned to the constituent elements that are the same as those in the antenna device 100 illustrated in FIG. 1, and the detailed descriptions thereof are not repeated.

The antenna device 100A1 illustrated in (a) of FIG. 5 includes a first antenna ANT1 and the second antenna ANT2. The first antenna ANT1 includes a first radiating element 110, the first coil L1 that is connected in series to the first radiating element 110, and the first conductor 11A that connects the first coil L1 to the ground. The first conductor 11A is connected in series to the feed circuit 30. The first radiating element 110 includes a first part 11a that is directly connected to the ground and a second part 11b that is directly connected to the first coil L1. The first part 11a and the second part 11b are capacitively coupled with each other at parts thereof that are arranged to face each other, and the first part 11a and the second part 11b constitute the single first radiating element 110 that forms the loop antenna. That is to say, all the parts of the first radiating element 110 are not connected to the feed circuit 30 via the first coil L1 and the first conductor 11A, and the first radiating element 110 has the part (first part 11a) that is indirectly connected to the feed circuit 30 through the capacitive coupling.

The antenna device 100A2 illustrated in (b) FIG. 5 includes the first antenna ANT1 and a second antenna ANT2. The second antenna ANT2 includes a second radiating element 120, the second coil L2 that is connected in series to the second radiating element 120, and the second conductor 12A that connects the second coil L2 to the ground. The second radiating element 120 includes a third part 12a, a first end portion of which forms an open end, and a fourth part 12b that is directly connected to the second coil. The third part 12a and the fourth part 12b are capacitively coupled with each other at parts thereof that are arranged to face each other, and the third part 12a and the fourth part 12b constitute the single second radiating element 120 that forms a monopole antenna. That is to say, all the parts of the second radiating element 120 are not connected to the ground via the second conductor 12A, and the second radiating element 120 has the part (third part 12a) that is indirectly connected to the ground through the capacitive coupling. Note that in the antenna device according to the present disclosure, a constituent element or elements of the antenna device 100A1 illustrated in (a) of FIG. 5 and a constituent element or elements of the antenna device 100A2 illustrated in (b) FIG. 5 may be combined. Further, a constituent element or elements of the antenna device 100A1 or 100A2 according to the modified example 1 may be combined with constituent elements of the embodiment described above and other modified examples.

### Modified Example 2

In the antenna device 100 illustrated in FIG. 1, the configuration is described in which the first radiating element 11 is connected to the feed circuit 30. However, instead of connecting the first radiating element 11 to the feed circuit 30, the second radiating element 12 may be connected to the feed circuit 30. FIG. 6 is a schematic diagram of an antenna device 100B according to a modified example 2. In the antenna device 100B illustrated in FIG. 6, the same reference characters are assigned to the constituent elements that are the same as those in the antenna device 100 illustrated in FIG. 1, and the detailed descriptions thereof are not repeated.

The antenna device 100B includes the first antenna ANT1 and the second antenna ANT2. The first antenna ANT1 includes the first radiating element 11, the transformer element 20 (first coil L1) that is connected in series to the first radiating element 11, and the first conductor 11A that connects the first coil L1 to the ground. The first antenna ANT1 functions as the loop antenna that includes the loop structure in which a first end portion of the first radiating element 11 is directly connected to the ground and a second end portion of the first radiating element 11 is indirectly connected to the ground via the transformer element 20 and the first conductor 11A.

The second antenna ANT2 includes the second radiating element 12, a first end portion of which forms an open end, the transformer element 20 (second coil L2) that is connected in series to the second radiating element 12, and the second conductor 12A that connects the transformer element 20 to the ground. The second conductor 12A is connected in series to the feed circuit 30. The second antenna ANT2 is an open-type antenna (for example, monopole antenna) in which the first end portion of the second radiating element 12 forms an open end and a second end portion of the second radiating element 12 is indirectly connected to the ground via the transformer element 20 and the second conductor 12A. Further, the transformer element 20 has the first coil L1 and the second coil L2, not shown in the drawing for ease of illustration, and the first coil L1 and the second coil L2 are magnetically coupled with each other. In the antenna device 100B, while the second antenna ANT2 functions as a fed antenna that receives power from the feed circuit 30, the first antenna ANT1 functions as a parasitic antenna that receives no power from the feed circuit 30.

In the antenna device 100B, as illustrated in FIG. 6, the second radiating element 12 is arranged outside the loop structure of the first antenna ANT1, which is formed from the first radiating element 11 and the ground. Because of this, the antenna device 100B is capable of alleviating the effects of the ground on the second radiating element 12 that forms the monopole antenna and offering broader frequency bands or compatibility with a plurality of frequency bands without degrading the antenna characteristic. Note that a constituent element or elements of the antenna device 100B according to the modified example 2 may be combined with constituent elements of the embodiment described above and other modified examples.

### Modified Example 3

FIG. 7 is a schematic diagram of an antenna device 100C according to a modified example 3. In the antenna device 100C illustrated in FIG. 7, the same reference characters are assigned to the constituent elements that are the same as those in the antenna device 100 illustrated in FIG. 1, and the detailed descriptions thereof are not repeated. A board, on which the antenna device 100C is provided, includes the area S1 where the first radiating element 11 is formed and the area S2 where the second radiating element 12 is formed. The shapes of the areas S1 and S2 are both rectangular. In the antenna device 100C, the length N1 of the part of the first radiating element 11 that extends in the longer side direction (left-and-right direction of the drawing) of the area S1 where the first radiating element 11 is formed is shorter than the length N2 of the part of the second radiating element 12 that extends in the longer side direction (left-and-right direction of the drawing) of the area S2 where the second radiating element 12 is formed (N1<N2). Further, the part of the first radiating element 11 that extends in the longer side direction of the area S1 where the first radiating element 11 is formed and the part of the second radiating element 12 that extends in the longer side direction of the area S2 where the second radiating element 12 is formed are arranged to run alongside each other.

In the antenna device 100C, the first radiating element 11 is connected to the feed circuit 30. Alternatively, the second radiating element 12 may be connected to the feed circuit 30. Further, a constituent element or elements of the antenna device 100C according to the modified example 3 may be combined with constituent elements of the embodiment described above and other modified examples.

### Modified Example 4

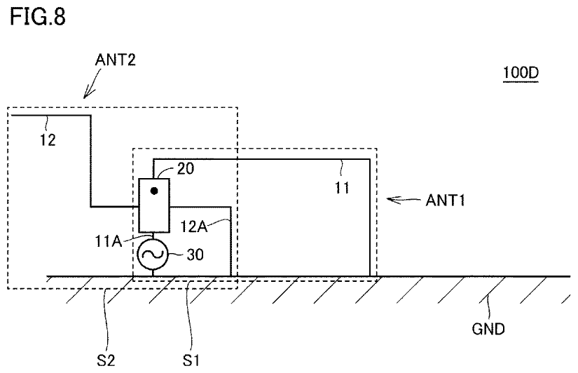

FIG. 8 is a schematic diagram of an antenna device 100D according to a modified example 4. In the antenna device 100D illustrated in FIG. 8, the same reference characters are assigned to the constituent elements that are the same as those in the antenna device 100 illustrated in FIG. 1, and the detailed descriptions thereof are not repeated. In the antenna device 100 illustrated in FIG. 1, the first part of the first radiating element 11 that extends in the longer side direction (left-and-right direction of the drawing) of the area S1 where the first radiating element 11 is formed and the second part of the second radiating element 12 that extends in the longer side direction (left-and-right direction of the drawing) of the area S2 where the second radiating element 12 is formed are arranged to run alongside each other. On the other hand, in the antenna device 100D illustrated in FIG. 8, the second radiating element 12 is arranged outside the loop structure of the first antenna ANT1. However, the first part of the first radiating element 11 that extends in the longer side direction of the area S1 where the first radiating element 11 is formed and the second part of the second radiating element 12 that extends in the longer side direction of the area S2 where the second radiating element 12 is formed are arranged toward different directions. In other words, the first part and the second part extend in parallel directions, but do not overlap along a direction orthogonal to the longer side direction and the first part is shorter than the second part.

Specifically, the part of the first radiating element 11 that extends in the longer side direction of the area S1 where the first radiating element 11 is formed extends toward the right side of the drawing from the transformer element 20. However, the part of the second radiating element 12 that extends in the longer side direction of the area S2 where the second radiating element 12 is formed extends toward the left side of the drawing from the transformer element 20. That is to say, in the antenna device 100D, the first radiating element 11 and the second radiating element 12 do not have parts that run alongside each other. When the first radiating element 11 and the second radiating element 12 are viewed from the ground side, the first radiating element 11 and the second radiating element 12 are arranged to not overlap each other. This improves the radiation performance of the first antenna ANT1 and the second antenna ANT2 in the antenna device 100D.

In the antenna device 100D, the first radiating element 11 is connected to the feed circuit 30. However, the first radiating element 11 may not be connected to the feed circuit 30. Alternatively, the second radiating element 12 may be connected to the feed circuit 30. Further, a constituent element or elements of the antenna device 100D according to the modified example 4 may be combined with constituent elements of the embodiment described above and other modified examples.

### Modified Example 5

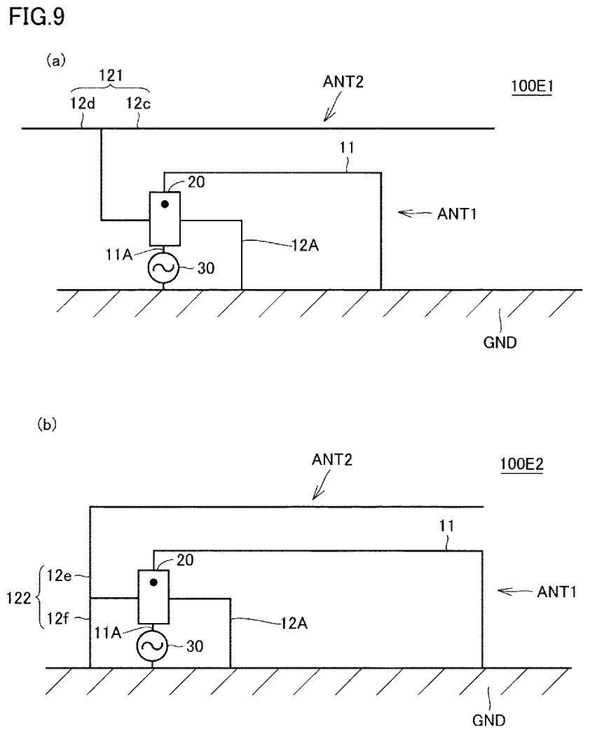

FIG. 9 illustrate an antenna device 100E according to a modified example 5. In the antenna devices 100E1 and 100E2 illustrated in (a) and (b) of FIG. 9, the same reference characters are assigned to the constituent elements that are the same as those in the antenna device 100 illustrated in FIG. 1, and the detailed descriptions thereof are not repeated. In the antenna device 100 illustrated in FIG. 1, the second radiating element 12 does not have a branched part. On the other hand, in the antenna devices 100E1 and 100E2 illustrated in (a) and (b) of FIG. 9, the second radiating element has a branched part.

The antenna device 100E1 illustrated in (a) of FIG. 9 includes the first antenna ANT1 and the second antenna ANT2. The second antenna ANT2 includes a second radiating element 121, the transformer element 20 (second coil L2) that is connected in series to the second radiating element 121, and the second conductor 12A that connects the transformer element 20 to the ground. The second radiating element 121 includes a main part 12c, the first end portion of which forms an open end, and a branched part 12d (second branched part) that branches off from the main part 12c. While the main part 12c extends toward the right side of the drawing, the branched part 12d extends toward the left side of the drawing, i.e. opposite the direction that the main part 12c that overlaps the first radiating element 11. One end portion of the branched part 12d forms an open end. Note that the resonant frequency of the second antenna ANT2 can be changed by adjusting the position from which the branched part 12d branches off, the direction in which the branched part 12d extends, and the lengths of the main part 12c and the branched part 12d.

The antenna device 100E2 illustrated in (b) of FIG. 9 includes the first antenna ANT1 and the second antenna ANT2. The second antenna ANT2 includes a second radiating element 122, the transformer element 20 (second coil L2) that is connected in series to the second radiating element 122, and the second conductor 12A that connects the transformer element 20 to the ground. The second radiating element 122 includes a main part 12e, a first end portion of which forms an open end, and a branched part 12f (second branched part) that branches off from the main part 12e. While the main part 12e extends upward in the drawing, the branched part 12f extends toward the ground direction, and a first end portion of the branched part 12f is directly connected to the ground. Second end portions of the main part 12e and the branched part 12f are connected. Note that the resonant frequency of the second antenna ANT2 can be changed by adjusting the position from which the branched part 12f branches off, the direction in which the branched part 12f extends, and the lengths of the main part 12e and the branched part 12f.

Furthermore, in the antenna device 100E2, compared with the total length of the main part 12e, the branched part 12f branches off from a position closer to the transformer element 20 (second coil L2) and is connected to the ground. Because of this, in the antenna device 100E2, the resonant energy of the second antenna ANT2 may be suppressed from flowing into the transformer element 20 (second coil L2) and reduce the radiation loss of the second antenna ANT2.

In the antenna devices 100E1 and 100E2, the first radiating element 11 is connected to the feed circuit 30. Alternatively, the second radiating elements 121 and 122 may be connected to the feed circuit 30. Further, a constituent element or elements of the antenna device 100D according to the modified example 5 may be combined with constituent elements of the embodiment described above and other modified examples.

### Modified Example 6

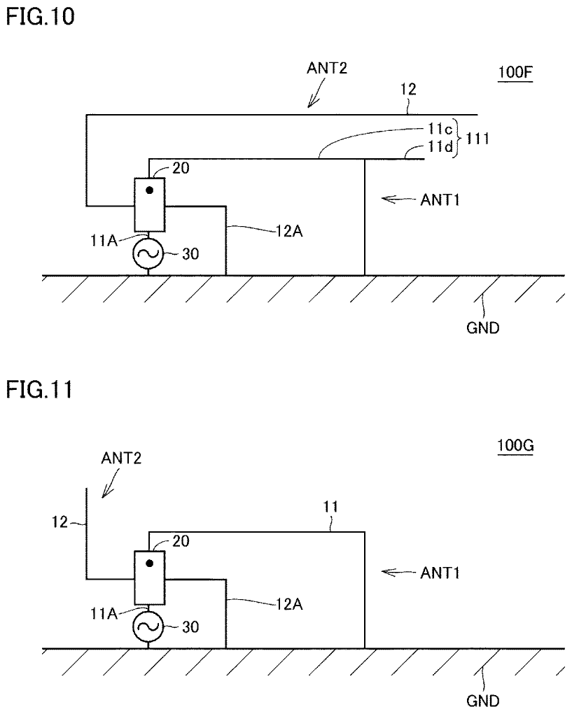

FIG. 10 is a schematic diagram of an antenna device 100F according to a modified example 6. In the antenna device 100F illustrated in FIG. 10, the same reference characters are assigned to the constituent elements that are the same as those in the antenna device 100 illustrated in FIG. 1, and the detailed descriptions thereof are not repeated. In the antenna device 100 illustrated in FIG. 1, the first radiating element 11 does not have a branched part. On the other hand, in the antenna device 100F illustrated in FIG. 10, the first radiating element has a branched part.

The antenna device 100F illustrated in FIG. 10 includes the first antenna ANT1 and the second antenna ANT2. The first antenna ANT1 includes a first radiating element 111, one end portion of which is directly connected to the ground, the transformer element 20 (first coil L1) that is connected in series to the first radiating element 111, and the first conductor 11A that connects the transformer element 20 to the ground. The first conductor 11A is connected in series to the feed circuit 30.

The first radiating element 111 includes a main part 11c that is directly connected to the ground and a branched part 11d (first branched part) that branches off from the main part 11c. The main part 11c functions as the loop antenna that includes the loop structure in which a first end portion of the main part 11c is directly connected to the ground (GND) and a second end portion of the main part 11c is indirectly connected to the ground via the transformer element 20 and the first conductor 11A. The branched part 11d extends toward the left side of the drawing. One end portion of the branched part 11d forms an open end. Note that by adjusting the position from which the branched part 11d branches off, the direction in which the branched part 11d extends, and the lengths of the main part 11c and the branched part 11d, the resonant frequency of the first antenna ANT1 can be changed, and the downsizing of the first antenna ANT1 can be achieved.

In the antenna device 100F, the first radiating element 111 is connected to the feed circuit 30. Alternatively, the second radiating element 12 may be connected to the feed circuit 30. Further, a constituent element or elements of the antenna device 100F according to the modified example 6 may be combined with constituent elements of the embodiment described above and other modified examples.

### Modified Example 7

FIG. 11 is a schematic diagram of an antenna device 100G according to a modified example 7. In the antenna device 100G illustrated in FIG. 11, the same reference characters are assigned to the constituent elements that are the same as those in the antenna device 100 illustrated in FIG. 1, and the detailed descriptions thereof are not repeated. In the antenna device 100 illustrated in FIG. 1, the total length of the second radiating element 12 is longer than the total length of the first radiating element 11. On the other hand, in the antenna device 100G illustrated in FIG. 11, the total length of the second radiating element 12 is shorter than the total length of the first radiating element 11.

Particularly in the antenna device 100G, because the second radiating element 12 is shorter, there is no part that runs alongside, i.e., overlaps, the first radiating element 11, and there is no overlapping between the first radiating element 11 and the second radiating element 12 when the first radiating element 11 and the second radiating element 12 are viewed from the ground side. Note that in the antenna device 100G, the first radiating element 11 is connected to the feed circuit 30. However, the first radiating element 11 may not be connected to the feed circuit 30. Alternatively, the second radiating element 12 may be connected to the feed circuit 30. Further, a constituent element or elements of the antenna device 100G according to the modified example 7 may be combined with constituent elements of the embodiment described above and other modified examples.

### Modified Example 8

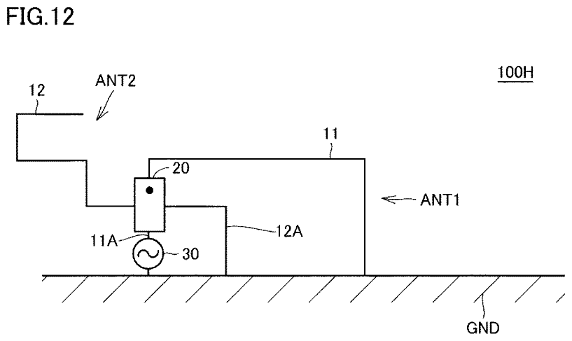

FIG. 12 is a schematic diagram of an antenna device 100H according to a modified example 8. In the antenna device 100H illustrated in FIG. 12, the same reference characters are assigned to the constituent elements that are the same as those in the antenna device 100 illustrated in FIG. 1, and the detailed descriptions thereof are not repeated. In the antenna device 100 illustrated in FIG. 1, the second radiating element 12 has two bent locations. On the other hand, in the antenna device 100H illustrated in FIG. 12, the second radiating element 12 has four bent locations, which is more bent locations than in the antenna device 100.

By increasing the bent locations of the second radiating element 12, it becomes possible to reduce the area where the second radiating element 12 is formed. Because of this, the antenna device 100H enables the downsizing of the second antenna ANT2. Note that in the antenna device 100H, the first radiating element 11 is connected to the feed circuit 30. Alternatively, the second radiating element 12 may be connected to the feed circuit 30. Further, a constituent element or elements of the antenna device 100H according to the modified example 8 may be combined with constituent elements of the embodiment described above and other modified examples.

### (Aspect)

(1) An antenna device according to the present disclosure is an antenna device comprising:
a first antenna including a loop structure; and
a second antenna of open type, wherein the first antenna includes
   a first radiating element, one end portion of which is directly connected to ground,
   a first coil that is connected in series to the first radiating element, and
   a first conductor that connects the first coil to the ground,
the second antenna includes
   a second radiating element, one end portion of which forms an open end,
   a second coil that is connected in series to the second radiating element and magnetically coupled with the first coil, and
   a second conductor that connects the second coil to the ground,
a feed circuit that transmits and receives a radio frequency signal is connected in series to the first radiating element or the second radiating element, and
the second radiating element is arranged outside the loop structure of the first antenna.

(2) In the antenna device according to (1), the first conductor is connected in series to the feed circuit.

(3) In the antenna device according to (1) or (2), the first radiating element includes a first part that is directly connected to the ground and a second part that is directly connected to the first coil, and the first part and the second part are capacitively coupled with one another at parts thereof that are arranged to face one another.

(4) In the antenna device according to (1), the second conductor is connected in series to the feed circuit.

(5) In the antenna device according to any one of (1) to (4), the second radiating element includes a third part, one end portion of which forms an open end, and a fourth part that is directly connected to the second coil, and the third part and the fourth part are capacitively coupled with one another at parts thereof that are arranged to face one another.

(6) In the antenna device according to any one of (1) to (5), a length of part of the first radiating element that extends in a longer side direction of an area where the first radiating element is formed is shorter than a length of part of the second radiating element that extends in a longer side direction of an area where the second radiating element is formed.

(7) In the antenna device according to (6), the part of the first radiating element that extends in the longer side direction of the area where the first radiating element is formed and the part of the second radiating element that extends in the longer side direction of the area where the second radiating element is formed are arranged to run alongside one another.

(8) In the antenna device according to (6), the part of the first radiating element that extends in the longer side direction of the area where the first radiating element is formed and the part of the second radiating element that extends in the longer side direction of the area where the second radiating element is formed are arranged toward different directions.

(9) In the antenna device according to any one of (1) to (8), the first radiating element has a first branched part, and one end portion that extends from the first branched part forms an open end.

(10) In the antenna device according to any one of (1) to (9), the second radiating element has a second branched part.

(11) In the antenna device according to (10), one end portion of the second branched part is directly connected to the ground.

(12) In the antenna device according to any one of (1) to (11), a resonant frequency of a fundamental wave of the first antenna is higher than a resonant frequency of a fundamental wave of the second antenna.

(13) In the antenna device according to (12), the resonant frequency of the fundamental wave of the first antenna is lower than a resonant frequency of a harmonic wave of the second antenna.

(14) In the antenna device according to (12), the resonant frequency of the fundamental wave of the first antenna is higher than a resonant frequency of a harmonic wave of the second antenna.

(15) An antenna device according to the present disclosure includes a feed circuit and the antenna device according to any one of (1) to (14).

It is to be understood that the embodiments disclosed herein are exemplary in all aspects and are not restrictive. It is intended that the scope of the present invention is defined by the claims, not by the description of the foregoing embodiments, and includes all variations which come within the meaning and range of equivalency of the claims.

### REFERENCE SIGNS LIST

11, 110 first radiating element
12, 120 second radiating element
11A first conductor
12A second conductor
20 transformer element
30 feed circuit
50 housing
60 board
100, 100A to 100H antenna device
200 communication terminal device

1. An antenna device comprising:
a first antenna including a loop structure; and
a second antenna of open type, wherein
the first antenna includes
a first radiating element having a first end portion directly connected to ground,
a first coil connected in series with the first radiating element, and
a first conductor that connects the first coil to the ground,
the second antenna includes
a second radiating element having a first end portion that forms an open end,
a second coil that is connected in series to the second radiating element and magnetically coupled with the first coil, and
a second conductor that connects the second coil to the ground,
a feed circuit that transmits and receives a radio frequency signal is connected in series with the first radiating element or the second radiating element, and
the second radiating element is arranged outside the loop structure of the first antenna.

2. The antenna device according to claim 1, wherein
the first conductor is connected in series to the feed circuit.

3. The antenna device according to claim 1, wherein
the first radiating element includes a first part that is directly connected to the ground and a second part that is directly connected to the first coil, and
the first part and the second part are capacitively coupled with one another at parts thereof that are arranged to face one another.

4. The antenna device according to claim 1, wherein
the second conductor is connected in series with the feed circuit.

5. The antenna device according to claim 1, wherein
the second radiating element includes a third part having a first end portion that forms an open end, and a fourth part that is directly connected to the second coil, and
the third part and the fourth part are capacitively coupled with one another at parts thereof that are arranged to face one another.

6. The antenna device according to claim 1, wherein
a first part of the first radiating element extends in a first direction for a first length,
a second part, separated from the first part along a direction orthogonal to the first direction, of the second radiating element extends in a second direction parallel to
the first direction for a second length, and
the first length is shorter than the second length.

7. The antenna device according to claim 6, wherein
the first part of the first radiating element and the second part of the second radiating element overlap one another along the direction orthogonal to the first.

8. The antenna device according to claim 7, wherein the first part of the first radiating element and the second part of the second radiating element extend to a same point at one end of the first and second directions.

9. The antenna device according to claim 6, wherein
the first part of the first radiating element and the second part of the second radiating element do not overlap along a direction orthogonal to the first and second directions.

10. The antenna device according to claim 1, wherein
the first radiating element has a first branched part, and a first end portion that extends from the first branched part forms an open end.

11. The antenna device according to claim 1, wherein
the second radiating element has a second branched part.

12. The antenna device according to claim 11, wherein
a first end portion of the second branched part is directly connected to the ground.

13. The antenna device according to claim 11, wherein the second branched part and a main part of the second radiating element extend in opposite directions from a common point.

14. The antenna device according to claim 1, wherein
a resonant frequency of a fundamental wave of the first antenna is higher than a resonant frequency of a fundamental wave of the second antenna.

15. The antenna device according to claim 14, wherein
the resonant frequency of the fundamental wave of the first antenna is lower than a resonant frequency of a harmonic wave of the second antenna.

16. The antenna device according to claim 14, wherein
the resonant frequency of the fundamental wave of the first antenna is higher than a resonant frequency of a harmonic wave of the second antenna.

17. A communication terminal device comprising:
a circuit board; and
the antenna device according to claim 1.

18. An antenna device, comprising:
a ground plane;
a loop antenna including a first radiating element having a first end directly connected to the ground plane;
an open-type antenna including a second radiating element having an open end; and
a transformer element including a first coil and a second coil magnetically coupled to each other, wherein
the first coil is electrically connected between a second end of the first radiating element and the ground plane,
the second coil is electrically connected between the second radiating element and the ground plane, and
the second radiating element is entirely outside of a loop formed by the first radiating element and the ground plane.

19. The antenna device according to claim 18, wherein the second radiating element includes a plurality of bends to reduce a surface area occupied by the second radiating element.
